(19) United States
(12) Patent Application Publication
(10) Pub. No.: US 2026/0369869 A1
(43) Pub. Date: Nov. 19, 2026

(54) ANTENNA, ELECTRONIC DEVICE, AND COMMUNICATION BASE STATION

(71) Applicant: ZTE CORPORATION, Shenzhen, Guangdong (CN)

(72) Inventors: Jun YANG, Shenzhen (CN); Yijian CHEN, Shenzhen (CN); Hongkang YU, Shenzhen (CN); Mengnan JIAN, Shenzhen (CN)

(21) Appl. No.: 19/144,137

(22) PCT Filed: Dec. 11, 2023
(86) PCT No.: PCT/CN2023/137842

§ 371 Date: Jun. 27, 2025

(30) Foreign Application Priority Data
Feb. 3, 2023 (CN) 202310106637.8

(51) Int. Cl. H01Q 1/24; H01Q 3/36; H01Q 9/04

(52) U.S. Cl. CPC H01Q 1/246; H01Q 3/36; H01Q 9/0414; H01Q 9/0457

(57) ABSTRACT

The present disclosure provides an antenna, an electronic device, and a communication base station. The antenna includes: a first functional device and a second functional device sequentially spaced apart in a first direction. The first function device includes M feed sources, each of which is used to transmit a first electromagnetic signal. The second functional device includes N transmissive units, each of which is configured to change a physical state of an electromagnetic signal passing through the transmissive unit; and the physical state of the electromagnetic signal includes one or more of: an amplitude, a phase, a frequency and a polarization direction. A distance between the first functional device and the second functional device is less than or equal to a preset multiple of a distance between two farthest-spaced transmissive units in the second functional device.

### CROSS-REFERENCE TO RELATED APPLICATION(S)

This application is a national phase entry under 35 USC 371 of International Patent Application No. PCT/CN2023/137842 filed on Dec. 11, 2023, the International Patent application claims a priority of Chinese Patent Application No. 202310106637.8, filed on Feb. 3, 2023, and the entire contents of the International Patent Application and the Chinese patent application are incorporated into this application by reference.

### TECHNICAL FIELD

The present disclosure relates to the field of wireless communication technologies, and in particular, relates to an antenna, an electronic device, and a communication base station.

### BACKGROUND

With the rapid development of wireless communication technologies, a large quantity of new wireless application scenarios and related industries have been emerged, enabling a wireless network to become a critical infrastructure. In turn, the new application scenarios impose higher requirements on a capacity and a rate of the wireless network.

Currently, a phased array, as a transmitting antenna, is generally adopted in a communication base station, for transmitting a wireless signal. All antenna elements in the phased array need to be coupled to a radio frequency link, and a phase of an electromagnetic signal transmitted out from an antenna element is manipulated by the radio frequency link, thereby achieving a directional transmission of the wireless signal; or, a manner of combining a radio frequency link with a phase shifter is adopted (i.e., a phase shifter is added between the radio frequency link and the antenna element) to control the phase of the antenna element, thereby achieving the directional transmission of the wireless signal.

### SUMMARY

In a first aspect, there is provided an antenna, where the antenna includes: a first functional device and a second functional device sequentially spaced apart in a first direction; the first functional device includes M feed sources; each feed source of the M feed sources is used to transmit a first electromagnetic signal, where M is an integer greater than or equal to 2; the second functional device includes N transmissive units; each transmissive unit of the N transmissive units is configured to change a physical state of an electromagnetic signal passing through the transmissive unit; the physical state of the electromagnetic signal includes one or more of: an amplitude, a phase, a frequency and a polarization direction, where N is an integer greater than or equal to 2; and a distance between the first functional device and the second functional device is less than or equal to a preset multiple of a distance between two farthest-spaced transmissive units in the second functional device.

In a second aspect, there is provided an electronic device, where the electronic device includes the antenna provided in the above first aspect.

In a third aspect, there is provided a communication device, where the communication device includes the electronic device provided in the above second aspect.

### BRIEF DESCRIPTION OF THE DRAWINGS

In order to explain the technical solutions in the present disclosure more clearly, the drawings to be required and used in some embodiments of the present disclosure will be introduced below briefly. It is obvious that the drawings in the following description are merely drawings of some embodiments of the present disclosure, and those ordinary skilled in the art may also obtain other drawings according to these drawings.

FIG. 1 is a structural schematic diagram of a communication base station provided in some embodiments of the present disclosure.

FIG. 2 is a structural schematic diagram of an antenna provided in some embodiments of the present disclosure.

FIG. 3 is a structural schematic diagram of an antenna module provided in some embodiments of the present disclosure.

FIG. 4 is a structural schematic diagram of a transmissive unit provided in some embodiments of the present disclosure.

FIG. 5 is a structural schematic diagram of another transmissive unit provided in some embodiments of the present disclosure.

FIG. 6A is a schematic diagram of an array arrangement provided in some embodiments of the present disclosure.

FIG. 6B is a schematic diagram of another array arrangement provided in some embodiments of the present disclosure.

FIG. 6C is a schematic diagram of yet another array arrangement provided in some embodiments of the present disclosure.

FIG. 7 is a structural schematic diagram of a radio frequency link provided in some embodiments of the present disclosure.

FIG. 8A is a schematic diagram of a projection of an array provided in some embodiments of the present disclosure.

FIG. 8B is a schematic diagram of a projection of another array provided in some embodiments of the present disclosure.

FIG. 9 is a structural schematic diagram of another antenna module provided in some embodiments of the present disclosure.

FIG. 10 is a structural schematic diagram of yet another antenna module provided in some embodiments of the present disclosure.

FIG. 11 is a schematic diagram of a phase response of a transmissive unit provided in some embodiments of the present disclosure.

FIG. 12 is a schematic diagram of a direction and a gain of a bean provided in some embodiments of the present disclosure.

FIG. 13 is a structural schematic diagram of yet another antenna module provided in some embodiments of the present disclosure.

FIG. 14 is a schematic diagram of a phase response of another transmissive unit provided in some embodiments of the present disclosure.

FIG. 15 is a structural schematic diagram of yet another antenna module provided in some embodiments of the present disclosure.

FIG. 16 is a structural schematic diagram of yet another antenna module provided in some embodiments of the present disclosure.

FIG. 17 is a seventh structural schematic diagram of yet another antenna module provided in some embodiments of the present disclosure.

### DETAILED DESCRIPTION

The technical solutions in the present disclosure will be described clearly and completely below in conjunction with the drawings in the present disclosure, and it is obvious that the described embodiments are only a part of the embodiments, but not all of the embodiments of the present disclosure. Based on the embodiments in the present disclosure, all other embodiments obtained by those ordinary skilled in the art without creative efforts shall fall within the protection scope of the present disclosure.

It should be noted that in the present disclosure, the words, such as “exemplary/exemplarily” or “for example”, etc., are used to represent an example, an illustration or an explanation. Any embodiments or design solutions described with “exemplary/exemplarily” or “for example” in the present disclosure should not be construed as preferred or advantageous over other embodiments or design solutions. Rather, the usage of the words, such as “exemplary/exemplarily” or “for example”, is intended to present relevant concepts in a specific manner.

Hereinafter, the terms, “first” and “second”, are used for descriptive purposes only, but cannot be understood as indicating or implying relative importance or implicitly specifying the number of the indicated technical features. Thus, features defined with “first” or “second” may explicitly or implicitly include one or more of such features.

In the description of the present disclosure, unless otherwise specified, the symbol “/” means “or”, for example, “A/B” may mean A or B. Herein, “and/or” is merely to describe an association relationship between associated objects, which represents that there may be three kinds of relationships. For example, A and/or B may mean: only A, only B, and A and B. In addition, “at least one” means one or more, and “multiple/a/the plurality of” means two or more than two.

When some embodiments are described, the expressions, “coupled” and “connected” and derivatives thereof, may be used. For example, when some embodiments are described, the term “connected” may be used to represent that two or more than two elements are in direct physical contact or electrical contact with each other. For another example, when some embodiments are described, the term “coupled” may be used to represent that two or more than two components are in direct physical contact or electrical contact with each other. However, the term “coupled” may also refer to that two or more than two components are not in direct contact with each other, but still cooperate or interact with each other. The embodiments disclosed herein are not necessarily limited to the contents herein.

Exemplary implementations are described herein with reference to cross-sectional views and/or plan views as idealized exemplary drawings. In the drawings, a thickness of a region is exaggerated for clarity. Therefore, it can be conceived of a change in a shape relative to the drawings due to, e.g., a manufacturing technology and/or a tolerance. Therefore, the exemplary implementations should not be construed as being limited to the shapes of the regions shown herein, but including a deviation in shape due to, e.g., manufacturing. Therefore, the regions shown in the drawings are schematic essentially and their shapes are not intended to show actual shapes of the regions of devices, and are not intended to limit the scope of the exemplary implementations.

The embodiments provided in the present disclosure are introduced specially below in conjunction with the drawings.

First, a communication base station involved in the embodiments of the present disclosure is introduced.

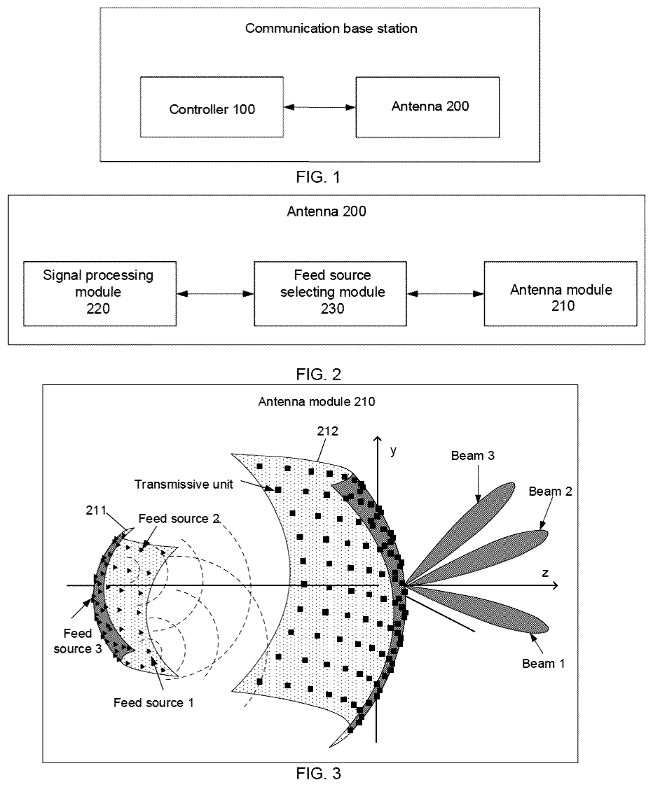

Referring to FIG. 1, FIG. 1 is a structural schematic diagram of a communication base station provided in the embodiments of the present disclosure. The communication base station is located between a communication network and a communication device (e.g., a mobile communication device) and is used to complete a transmission of an electromagnetic signal between the communication network and the communication device.

As shown in FIG. 1, the communication base station includes: a controller 100 and an antenna 200.

The controller 100 is used to manage a wireless channel. For example, when the antenna 200 is used for wireless communication, the controller 100 may allocate a wireless channel for a voice service received by the antenna 200.

The antenna 200 is used to transmit an electromagnetic signal and receive an electromagnetic signal.

Exemplarily, after the electromagnetic signal is received by the antenna 200, the antenna 200 extracts information (e.g., voice service information) carried in the electromagnetic signal, and the information is transmitted through the wireless channel allocated by the controller 100.

As described in the background, the antenna 200 provided in the related art may be a phased array, where the phased array is a two-dimensional array composed of a large quantity of antenna elements arranged in equal spacings. When a signal is transmitted, an overall direction of a transmission beam is controlled by controlling a phase of an electromagnetic signal transmitted from each antenna element on the phased array, thereby achieving a directional transmission of a wireless signal. For example, each antenna element on the phased array is coupled to a radio frequency link, and a phase of an electromagnetic signal transmitted out from the antenna element is manipulated by the radio frequency link, thereby achieving a directional transmission of a wireless signal; or, a manner of combining a radio frequency link with a phase shifter is adopted (i.e., a phase shifter is added between the radio frequency link and the antenna element) to manipulate a phase of an electromagnetic signal transmitted out from the antenna element, thereby achieving a directional transmission of a wireless signal.

It can be seen that the antenna 200 provided in the related art needs to be equipped with numerous radio frequency links or phase shifters, which results in a complex structure and high cost of an antenna, and is not conducive to popularization and usage.

Based on the above problems, the embodiments of the present disclosure provide an antenna with a simple structure and low cost. Referring to FIG. 2, FIG. 2 is a structural schematic diagram of an antenna 200 provided in the embodiments of the present disclosure. As shown in FIG. 2, the antenna 200 includes: an antenna module 210, a signal processing module 220 and a feed source selecting module 230.

The antenna module 210 is configured to transmit a first electromagnetic signal (the first electromagnetic signal is an electromagnetic signal generated by the signal processing module 220 and transmitted by a feed source in a first functional device) and to receive a second electromagnetic signal radiated from an external space. The signal processing module 220 is configured to generate the first electromagnetic signal, and to receive and process the second electromagnetic signal received by the antenna module 210. The feed source selecting module 230 is configured to select a target feed source, so that the target feed source transmits the first electromagnetic signal generated by the signal processing module 220.

Referring to FIG. 3, FIG. 3 is a structural schematic diagram of an antenna module 210 provided in the embodiments of the present disclosure. As shown in FIG. 3, the antenna module 210 includes: a first functional device 211 and a second functional device 212.

In some embodiments, the first functional device 211 and the second functional device 212 are sequentially spaced apart in a first direction. The first direction may be any direction. For example, the first direction may be a z-axis direction as shown in FIG. 3.

In some embodiments, a distance between the first functional device 211 and the second functional device 212 is less than or equal to a preset multiple of a distance between two farthest-spaced transmissive units in the second functional device 212. The preset multiple may be determined according to actual conditions, for example, the preset multiple may be 5 times or 8 times, etc.

Exemplarily, in a case where both a surface where the first functional device 211 is located and a surface where the second functional device 212 is located are planes, the distance between the first functional device 211 and the second functional device 212 refers to a distance between center points of the two planes; in a case where both the surface where the first functional device 211 is located and the surface where the second functional device 212 is located are curved surfaces, the distance between the first functional device 211 and the second functional device 212 refers to a distance between center points of the two curved surfaces; and in a case where one of the surfaces where the first functional device 211 and the second functional device 212 are located is a curved surface and the other of the surfaces where the first functional device 211 and the second functional device 212 are located is a plane, the distance between the first functional device 211 and the second functional device 212 refers to a distance between a center point of the plane and a center point of the curved surface.

In some embodiments, in the first direction, the first functional device 211 and the second functional device 212 are disposed at least partially opposite to each other, that is, a projection of the first functional device 211 in the first direction is at least partially projected onto the second functional device 212.

The first functional device 211 includes M feed sources, where M is an integer greater than or equal to 1.

The M feed sources are used to be coupled to the feed source selecting module 230, and the feed source selecting module 230 is coupled to the signal processing module 220. For example, the signal processing module 220 is configured to generate the first electromagnetic signal and send the first electromagnetic signal to the feed source selecting module 230. The feed source selecting module 230 selects the target feed source from the M feed sources (the target feed source may be any one feed source of the M feed sources), so that the target feed source transmits the first electromagnetic signal.

In addition, the feed source is further used to receive the second electromagnetic signal (the second electromagnetic signal is an electromagnetic signal radiated from an external space and received by a transmissive unit in the second functional device 212).

In some embodiments, the feed source may be a half-wave dipole, a monopole, a microstrip antenna, a slot antenna, a horn antenna or other antenna structures with a transmitting capability and a reception capability for an electromagnetic signal. The embodiments of the present disclosure do not limit the specific form of the feed source.

In some embodiments, the first functional device 211 may include a feed source surface for supporting and fixing the feed source. In some embodiments, the feed source surface may be a plane or a curved surface.

It can be understood that the embodiments of the present disclosure do not limit the shape of the first functional device 211. The feed source surface included in the first functional device 211 may be a plane or a curved surface. In actual usage, factors, such as manufacturing complexity, cost, weight, volume, and electromagnetic reflection interference, etc., may be comprehensively considered to determine an optimal shape of the first functional device 211.

The second functional device 212 includes N transmissive units, where the N is an integer greater than or equal to 2.

The transmissive unit is a passive transmissive unit, that is, the transmissive unit does not have the capability to transmit an electromagnetic signal independently. The transmissive unit is configured to change a physical state of the electromagnetic signal passing through the transmissive unit. The physical state of the electromagnetic signal includes one or more of: an amplitude, a phase, a frequency and a polarization direction.

Exemplarily, in a case where the physical state of the electromagnetic signal includes a phase, a phase of an electromagnetic signal incident into the transmissive unit is different from a phase of an electromagnetic signal passing through the transmissive unit (i.e., there is a phase difference between the two electromagnetic signals). In a case where the physical state of the electromagnetic signal includes an amplitude, an amplitude of an electromagnetic signal incident into the transmissive unit is different from an amplitude of an electromagnetic signal passing through the transmissive unit. In a case where the physical state of the electromagnetic signal includes a polarization direction, a polarization direction of an electromagnetic signal incident into the transmissive unit is different from a polarization direction of an electromagnetic signal passing through the transmissive unit. In a case where the physical state of the electromagnetic signal includes a frequency, a frequency of an electromagnetic signal incident into the transmissive unit is different from a frequency of an electromagnetic signal passing through the transmissive unit.

In some embodiments, the transmissive unit may be static, that is, a change in the physical state of the electromagnetic signal by the transmissive unit is fixed. For example, in a case where the physical state of the electromagnetic signal includes a phase, an amount of change in the phase of the electromagnetic signal by the transmissive unit is fixed. For example, a phase of an electromagnetic signal incident into the transmissive unit is 100°, and a phase of an electromagnetic signal passing through the transmissive unit is 150°, that is, an amount of change in the phase of the electromagnetic signal by the transmissive unit is a fixed value of 50°.

The above amount of change in the phase refers to a difference between a phase of an electromagnetic signal incident into the transmissive unit and a phase of an electromagnetic signal passing through the transmissive unit.

In some embodiments, the transmissive unit may be dynamic, that is, a change in the physical state of the electromagnetic signal by the transmissive unit can be dynamically adjusted. For example, in a case where the physical state of the electromagnetic signal includes a phase, an amount of change in the phase of the electromagnetic signal by the transmissive unit may be changed dynamically according to different incident directions of the electromagnetic signal. For example, an amount of change in the phase of the electromagnetic signal incident into the transmissive unit along a first incident direction is different from an amount of change in the phase of the electromagnetic signal incident into the transmissive unit along a second incident direction.

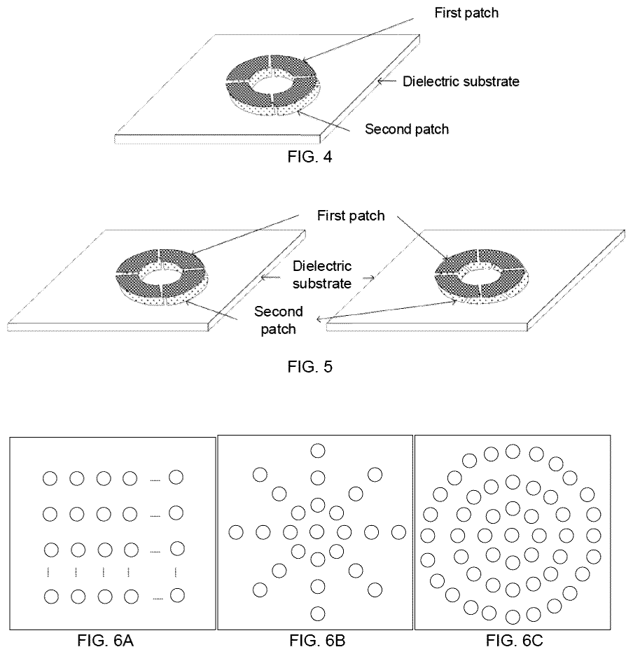

In some embodiments, the transmissive unit may be composed of R types of basic units, where R is an integer greater than or equal to 1. Exemplarily, the above basic unit may be a patch (e.g., a metal patch), a dielectric substrate, etc. Exemplarily, as shown in FIG. 4, the transmissive unit may include: a first patch, a second patch, and a dielectric substrate; and the dielectric substrate is sandwiched between the first patch and the second patch. The above first patch and second patch are used to adjust the physical state of the electromagnetic signal passing through the transmissive unit.

Exemplarily, as shown in FIG. 5, both the first patch and the second patch of the transmissive unit are annular patches, and a change in the physical state of the electromagnetic signal by the transmissive unit may be changed by adjusting a direction of an opening of the two annular patches of the transmissive unit. For example, an amount of change in the phase of the electromagnetic signal by the transmissive unit is changed; and/or, an amount of change in the amplitude of the electromagnetic signal by the transmissive unit is changed; and/or, an amount of change in the polarization direction of the electromagnetic signal by the transmissive unit is changed; and/or, an amount of change in the frequency of the electromagnetic signal by the transmissive unit is changed. The directions of the openings of the two annular patches, an upper annular patch and a lower annular patch, of the transmissive unit on the left side of FIG. 5 are the same as each other; and the directions of the openings of the two annular patches on the right side are different from each other by 45°.

The above amount of change in the amplitude refers to a difference between an amplitude of an electromagnetic signal incident into the transmissive unit and an amplitude of an electromagnetic signal passing through the transmissive unit. The above amount of change in the polarization direction refers to an angular difference between a polarization direction of an electromagnetic signal incident into the transmissive unit and a polarization direction of an electromagnetic signal passing through the transmissive unit. The above amount of change in the frequency refers to a frequency difference between a frequency of an electromagnetic signal incident into the transmissive unit and a frequency of an electromagnetic signal passing through the transmissive unit.

It can be understood that the manner shown in FIG. 5 is merely an example and does not constitute a limitation on the embodiments of the present disclosure. In some other embodiments, the change in the physical state of the electromagnetic signal by the transmissive unit may be changed, by changing a rotation angle, a scaling size, a width and a length, a size of an opening and the number of openings, of the first patch and the second patch, or a material of the dielectric substrate.

In some embodiments, the second functional device 212 may include a plane or a curved surface for supporting and fixing the transmissive unit. In some embodiments, a surface where the second functional device 212 is located may be a plane or a curved surface.

It can be understood that the embodiments of the present disclosure do not limit the shape of the second functional device 212. The surface where the second functional device 212 is located may be a plane or a curved surface. In actual usage, factors such as manufacturing complexity, cost, weight, volume, and electromagnetic reflection interference, etc., may be comprehensively considered to determine an optimal shape of the second functional device 212.

In some embodiments, the M feed sources in the first functional device 211 are arranged in an array, e.g., in a linear array, in a curved line array, in a planar array, or in a curved surface array (i.e., the surface where the first functional device 211 is located is a curved surface, and projections of the M feed sources in the first functional device 211 on a first plane are arranged in an array, where the first plane is a plane perpendicular to the first direction), etc. The N transmissive units in the second functional device 212 are arranged in an array, e.g., in a linear array, in a curved line array, in a planar array or in a curved surface array (i.e., the surface where the second functional device 212 is located is a curved surface, and projections of the N transmissive units in the second functional device 212 on the first plane are arranged in an array), etc.

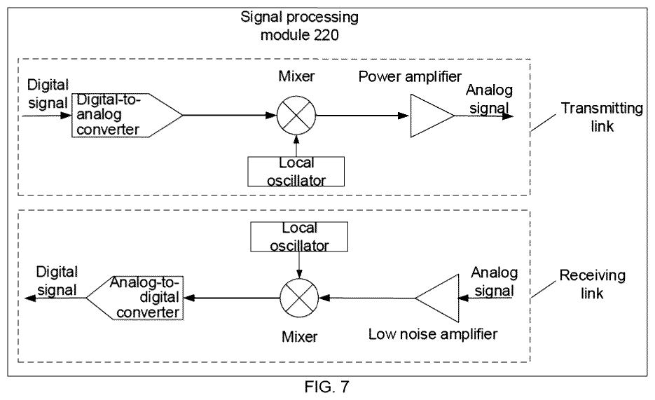

In some embodiments, the above array arrangement may be an array arrangement with equal spacings; or, an array arrangement with unequal spacings. In addition, the embodiments of the present disclosure do not limit the array arrangement manner. For example, as shown in FIG. 6A, the array arrangement manner may be an array arrangement manner of a checkerboard pattern; for another example, as shown in FIG. 6B, the array arrangement manner may be an array arrangement manner of a radial pattern; and for another example, as shown in FIG. 6C, the array arrangement manner may be an array arrangement manner of an annulus. In the array arrangement manner of the annulus shown in FIG. 6C, a plurality of units (e.g., feed sources or transmissive units) constituting each circular ring are arranged in equal spacings.

It can be understood that when the array arrangement manner is a one-dimensional arrangement manner (e.g., a linear array or a curved line array), a one-dimensional beam scanning may be achieved; and when the array arrangement manner is a two-dimensional arrangement manner (e.g., a planar array or a curved surface array), a two-dimensional beam scanning may be achieved. It can be seen that the antenna module 210 provided in the embodiments of the present disclosure may achieve beam manipulation by changing the array arrangement manner.

It can be understood that when both the M feed sources in the first functional device 211 and the N transmissive units in the second functional device 212 are arranged in a planar array, the structure of the antenna module 210 is relatively simple, easy to design and manufacture, and can reduce the size of the antenna module 210 in the first direction. When both the M feed sources in the first functional device 211 and the N transmissive units in the second functional device 212 are arranged in a curved surface array, the antenna module 210 follows the principle of equal optical path when both transmitting an electromagnetic signal and receiving an electromagnetic signal, so that the performance of the beam that is radiated out is improved and the received electromagnetic signal may be better focused on the feed source of the first functional device 211.

In addition, there may also be other combination manners of the first functional device 211 with the second functional device 212 in the antenna module 210 provided in the embodiments of the present disclosure. For example, the M feed sources in the first functional device 211 are arranged in a curved surface array, and the N transmissive units in the second functional device 212 are arranged in a planar array; or, the M feed sources in the first functional device 211 are arranged in a planar array, and the N transmissive units in the second functional device 212 are arranged in a curved surface array. In actual usage, the arrangement manner of the M feed sources in the first functional device 211 and the arrangement manner of the N transmissive units in the second functional device 212 may be flexibly selected according to requirements.

In some embodiments, a distance between two farthest-spaced feed sources in the first functional device 211 is smaller than the distance between the farthest-spaced two transmissive units in the second functional device 212. The distance between the two farthest-spaced feed sources in the first functional device 211 may be referred to as a maximum aperture of the first functional device 211, and the distance between the farthest-spaced two transmissive units in the second functional device 212 is referred to as a maximum aperture of the second functional device 212. Therefore, it may also be described that the maximum aperture of the first functional device 211 is smaller than the maximum aperture of the second functional device 212.

It can be understood that, since the feed source is used to transmit an electromagnetic signal and receive an electromagnetic signal, the feed source needs to be connected to multiple functional devices, e.g., the signal processing module 220 and the feed source selecting module 230, etc., and has a relatively complicated design. The transmissive unit is a passive transmissive unit and does not have the capability of independently transmitting an electromagnetic signal. Therefore, the transmissive unit has a relatively simple structure, and relatively low design cost and manufacturing cost. Therefore, in the antenna module 210 provided in the embodiments of the present disclosure, the maximum aperture of the first functional device 211 is smaller than the maximum aperture of the second functional device 212, so that the antenna module 210 has a large aperture and can transmit out a narrower beam, thereby improving the performance of the beam; and meanwhile, the hardware cost and power consumption of the antenna module 210 can also be reduced.

In some embodiments, there may be an open space between the first functional device 211 and the second functional device 212, and in this way, the design complexity of the antenna module 210 can be reduced and meanwhile the weight and cost of the antenna module 210 are reduced.

In some other embodiments, the first functional device 211 intersects with the second functional device 212, and a cavity is formed between the first functional device 211 and the second functional device 212 (e.g., the first functional device 211 and the second functional device 212 may extend toward each other and intersect with each other to form a cavity). In this way, a radiation efficiency of the electromagnetic signal can be enhanced and the interference of an external environment on the electromagnetic signal can be reduced. In some embodiments, the cavity formed between the first functional device 211 and the second functional device 212 may be a closed cavity; or, the cavity formed between the first functional device 211 and the second functional device 212 may be an open cavity.

In some embodiments, a filling material is further included between the first functional device 211 and the second functional device 212.

As an implementation, the filling material may be air, and in this way, the weight and cost of the antenna module 210 can be reduced.

As another implementation, the filling material may be a dielectric material, and in this way, a size of the antenna module 210 may be reduced in the first direction. In some embodiments, the dielectric material may be a material having a dielectric constant greater than a preset threshold. The preset threshold may be determined according to the dielectric constant of the dielectric material and an absorbent capacity of the dielectric material to the electromagnetic signal. It can be understood that, the larger the dielectric constant of the dielectric material is, the more the size of the antenna module 210 may be reduced in the first direction. Therefore, the larger the dielectric constant of the dielectric material is, the better is. However, since the larger the dielectric constant of the material is, the stronger the absorbent capacity to the electromagnetic signal is, in the embodiments of the present disclosure, the dielectric material filled between the first functional device 211 and the second functional device 212 needs to be determined according to the dielectric constant of the dielectric material and the absorbent capacity of the dielectric material to the electromagnetic signal.

Exemplarily, the dielectric material may be FR-4 material. The dielectric constant of the FR-4 material is relatively high, about 4.5, and the absorbent capacity of the FR-4 material to the electromagnetic signal is relatively weak.

The signal processing module 220 is configured to generate a first electromagnetic signal and receive a second electromagnetic signal received by the antenna module 210.

As an implementation, the signal processing module 220 includes a radio frequency link, where the radio frequency link is used to convert a received digital signal into an electromagnetic signal, and convert a received electromagnetic signal into a digital signal.

Exemplarily, as shown in FIG. 7, the radio frequency link includes: a transmitting link and a receiving link.

The transmitting link includes: a digital-to-analog converter, a mixer, a local oscillator and a power amplifier.

For example, the digital-to-analog converter is used to receive a digital signal, convert the digital signal into an analog signal, and send the analog signal to the mixer. The mixer is used to perform frequency conversion processing on the analog signal and a high-frequency carrier provided by the local oscillator to obtain a radio frequency modulated signal. The power amplifier is used to amplify the radio frequency modulated signal to obtain a first electromagnetic signal that may be transmitted by the antenna module 210.

The receiving link includes: a low noise amplifier, a mixer, a local oscillator and an analog-to-digital converter.

For example, the low noise amplifier is used to receive a second electromagnetic signal that is coupled into from the antenna module 210, amplify the second electromagnetic signal, and send an amplified second electromagnetic signal to the mixer. The mixer is used to perform down-conversion processing on the amplified second electromagnetic signal and a local oscillation signal to obtain a signal containing an intermediate frequency component. A filter is used to filter out an intermediate frequency component signal from the signal containing the intermediate frequency component. The analog-to-digital converter is used to convert the intermediate frequency component signal into a digital signal and output the digital signal.

The feed source selecting module 230 is configured to select a target feed source from the M feed sources, so that the target feed source transmits the first electromagnetic signal generated by the signal processing module 220.

The target feed source may be any one or more feed sources of the M feed sources. For example, the target feed source may be m feed sources in the M feed sources, where m is an integer greater than or equal to 1 and less than or equal to M.

In some embodiments, the above target feed source may be determined by the signal processing module 220. For example, the signal processing module 220 determines the target feed source and sends an identifier of the target feed source to the feed source selecting module 230. Then, the feed source selecting module 230 selects the target feed source from the M feed sources according to the identifier of the target feed source and controls the target feed source to be turned on, so that the target feed source transmits the first electromagnetic signal generated by the signal processing module 220.

In some embodiments, the feed source selecting module 230 may be composed of an automatic switching circuit, and the automatic switching circuit can turn on the target feed source according to indication from the signal processing module 220. The embodiments of the present disclosure do not limit the specific form of the automatic switching circuit.

It should be noted that the antenna 200 provided in the embodiments of the present disclosure can be used as not only a transmitting antenna to transmit a first electromagnetic signal to the external space, but also a receiving antenna to receive a second electromagnetic signal radiated from the external space.

For example, when the antenna 200 is used as a transmitting antenna, the signal processing module 220 can generate a first electromagnetic signal and send the first electromagnetic signal to the feed source selecting module 230; the feed source selecting module 230 selects m feed sources from the M feed sources (i.e., m feed sources are used as target feed sources) in the first functional device 211, and the m feed sources transmit the first electromagnetic signal, respectively; the first electromagnetic signal is radiated outward through the N transmissive units in the second functional device 212 to form directional beams in k specified directions; where k is an integer greater than or equal to 1 and less than or equal to m.

Exemplarily, as shown in FIG. 3, a first electromagnetic signal transmitted by an i-th feed source in the m feed sources may be formed into a directional beam in an i-th direction by the N transmissive units in the second functional device 212. For example, when a feed source 1 in the m feed sources is selected to transmit the first electromagnetic signal, a beam 1 may be radiated to the external space by the N transmissive units in the second functional device 212; when it is switched to a feed source 2 or a feed source 3, a beam 2 or a beam 3 may be radiated to the external space by the N transmissive units in the second functional device 212; and when the feed source 1, feed source 2 and feed source 3 transmit the first electromagnetic signal simultaneously, a beam 1, a beam 2 and a beam 3 are radiated to the external space by the N transmissive units in the second functional device 212, where the directions of the beam 1, the beam 2 and the beam 3 are different from each other.

It can be understood that in the antenna 200 provided in the embodiments of the present disclosure, one or more feed sources in the first functional device 211 of the antenna module 210 are selected by the feed source selecting module 230 to transmit the first electromagnetic signal, and then one or more directional beams are formed by radiation of the N transmissive units in the second functional device 212 to the external space. It can be seen that the antenna provided in the embodiments of the present disclosure does not need to adopt complicated devices, such as a phase shifter, etc., and has a relatively simple structure and low cost.

When the antenna 200 is used as a receiving antenna, the N transmissive units in the second functional device 212 of the antenna module 210 are also configured to receive a second electromagnetic signal radiated from an external space; and send the second electromagnetic signal to m feed sources among the M feed sources. The m feed sources are used to transmit the second electromagnetic signal to the signal processing module 220; and the signal processing module 220 is further configured to process the second electromagnetic signal.

In summary, the antenna 200 provided in the embodiments of the present disclosure includes: an antenna module 210, a signal processing module 220 and a feed source selecting module 230. The signal processing module 220 is configured to generate a first electromagnetic signal and receive a second electromagnetic signal. The feed source selecting module 230 is configured to select a target feed source to transmit the first electromagnetic signal. The antenna module 210 includes a first functional device 211 and a second functional device 212. M feed sources in the first functional device 211 are arranged in an array (e.g., a one-dimensional array or a two-dimensional array), and N transmissive units in the second functional device 212 are arranged in an array (e.g., a one-dimensional array or a two-dimensional array). It can be seen that compared with an array antenna provided in the related art that requires a large quantity of radio frequency links or phase shifters for phase control, the antenna 200 provided in the embodiments of the present disclosure can achieve phase manipulation of the electromagnetic signal without a large quantity of radio frequency links or a phase shifter, thereby being capable of reducing design complexity, reducing cost and reducing power consumption.

For ease of understanding, the structure of the antenna module 210 in the antenna 200 provided in the embodiments of the present disclosure is explained below in the form of an example.

Implementation one: the surface where the first functional device 211 is located is a curved surface, and the surface where the second functional device 212 is located is a curved surface.

In some embodiments, as shown in FIG. 3, the surface where the first functional device 211 is located is a curved surface, and the surface where the second functional device 212 is located is a curved surface. In some embodiments, a protruding direction of the first functional device 211 and a protruding direction of the second functional device 212 are away from each other. Projections of the M feed sources in the first functional device 211 on a first plane are arranged in an array; and projections of the N transmissive units in the second functional device 212 on the first plane are arranged in an array. The first plane is a plane perpendicular to the first direction.

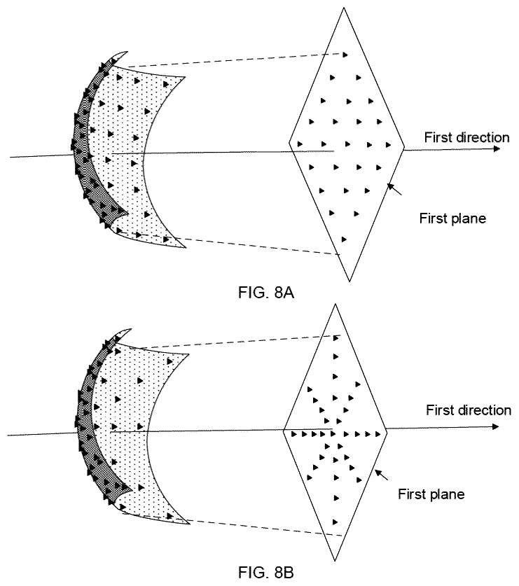

In some embodiments, the projections of the M feed sources in the first functional device 211 on the first plane are arranged in an array with equal spacings; or, the projections of the M feed sources in the first functional device 211 on the first plane are arranged in an array with unequal spacings. In addition, the embodiments of the present disclosure do not limit the array arrangement manner of the M feed sources. For example, as shown in FIG. 8A, the projections of the M feed sources on the first plane may have an array arrangement manner of a checkerboard pattern. For another example, as shown in FIG. 8B, the projections of the M feed sources on the first plane may have an array arrangement manner of a radial pattern.

In some embodiments, the projections of the N transmissive units in the second functional device 212 on the first plane are arranged in an array with equal spacings; or, the projections of the N transmissive units in the first functional device 211 on the first plane are arranged in an array with unequal spacings. In addition, the embodiments of the present disclosure do not limit the array arrangement manner of the N transmissive units. For example, the projections of the N transmissive units on the first plane may have an array arrangement manner of a checkerboard pattern. For another example, the projections of the N transmissive units on the first plane may have an array arrangement manner of a radial pattern.

In some embodiments, as shown in FIG. 9, at least one feed source of the M feed sources in the first functional device 211 is arranged on an intersection line of the first functional device 211 with a second plane (in FIG. 9, that all the M feed sources are arranged on the intersection line of the first functional device 211 with the second plane is taken as an example for explanation). The second plane is a plane intersecting with the first functional device 211 and parallel to the first direction. The projections of the N transmissive units in the second functional device 212 on the first plane are arranged in an array.

It can be understood that the embodiments of the present disclosure do not limit the array arrangement manner of the M feed sources in the first functional device 211. Exemplarily, when the array arrangement manner of the M feed sources in the first functional device 211 is a one-dimensional arrangement manner (e.g., a linear array or a curved line array), a one-dimensional beam scanning may be achieved; and when the array arrangement manner of the M feed sources in the first functional device 211 is a two-dimensional arrangement (e.g., a planar array or a curved surface array), a two-dimensional beam scanning may be achieved. It can be seen that the antenna module 210 provided in the embodiments of the present disclosure can achieve beam manipulation by changing the array arrangement manner.

In some embodiments, according to the principle of equal optical path (an optical path of an electromagnetic signal transmitted from any feed source in the first functional device 211 and propagating through any transmissive unit of the second functional device 212 is the same as an optical path of an electromagnetic signal propagating through the transmissive unit at a center point of the second functional device 212), the positions of the M feed sources in the first functional device 211, the positions of the N transmissive units in the second functional device 212, and a change in the physical state of the electromagnetic signal by the N transmissive units are determined, so as to achieve that a first electromagnetic signal passing through a feed source in the first functional device 211 can radiate out through the N transmissive units in the second functional device 212 to form a directional beam.

Exemplarily, the first functional device 211 in the antenna module 210 shown in FIG. 3 includes two perfect focuses: a first focus and a second focus, that is, second electromagnetic signals incident on the second functional device 212 from two specified directions may be focused on the two perfect focuses, respectively. For example, the first focus refers to a point on the first functional device 211 where the second electromagnetic signal incident on the second functional device 212 from a first specified direction is focused; and the second focus refers to a point on the first functional device 211 where the second electromagnetic signal incident on the second functional device 212 from the second specified direction is focused.

The positions of the above first focus and second focus are determined by two focal axes (a first focal axis and a second focal axis) and two focal axis azimuths ((α1, β1) and (α2, β2)). The two focal axis azimuths are determined by connection lines between the two perfect focuses and a target reference point (e.g., a center point of the second functional device 212).

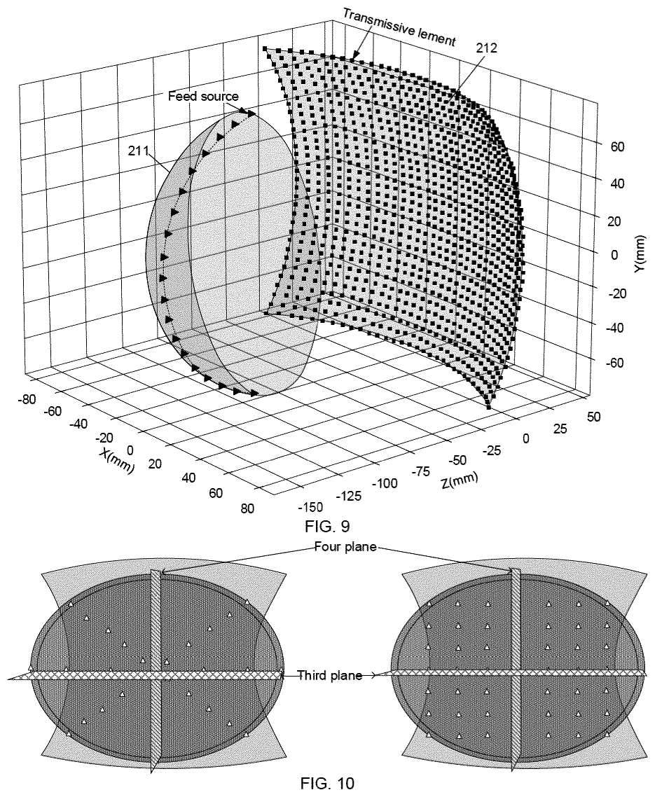

Exemplarily, as shown in FIG. 10, the two perfect focuses may be located on intersection lines of the first functional device 211 with a third plane and a fourth plane, respectively. For example, the first focus is located on the intersection line of the first functional device 211 with the third plane; and the second focus is located on the intersection line of the first functional device 211 with the fourth plane. The third plane is a plane parallel to the first direction, and the fourth plane is a plane intersecting with the third plane. For example, an angle between the third plane and the fourth plane may be 90°.

In some embodiments, the M feed sources in the first functional device 211 may be determined according to the position of the first focus and the position of the second focus. For example, the M feed sources may be disposed at the first focus and the second focus; and/or, the M feed sources may be divided into two groups, one group is located on the intersection line of the first functional device 211 with the third plane, and the other group is located on the intersection line of the first functional device 211 with the fourth plane.

In some embodiments, the positions of the N transmissive units in the second functional device 212 may be determined according to the principle of equal optical path. It is assumed that a center coordinate of an n-th transmissive unit in the N transmissive units is (xₙ, yₙ, zₙ), and according to the principle of equal optical path, (xₙ, yₙ, zₙ) may satisfy the following Formula (1):

$${z}_{n} = - F sin α \pm \sqrt{{F}^{2} {cos}^{2} α {tan}^{2} ϕ - {y}_{n}^{2} {sin}^{2} ϕ - {x}_{n}^{2}} \qquad Formula ( 1 )$$

where α is an off-focus axis angle, φ is a maximum beam scanning angle, and F is an off-focus axis length.

In a case where the physical state of the electromagnetic signal includes a phase, the amount of change in the phase of the electromagnetic signal by the n-th transmissive unit is φₙ, which may satisfy the following Formula (2):

$${ϕ}_{n} = \frac{2 π}{λ} [ F ( 1 - \frac{cos α}{cos ϕ} ) + {z}_{n} sin ϕ ] \qquad Formula ( 2 )$$

where λ represents a wavelength of the electromagnetic signal.

It can be seen that according to the above Formula (1) and Formula (2), by giving the parameters F, α, and φ and the center coordinate of the transmissive unit in the second functional device, the positions of the feed sources in the first functional device 211, the positions of the transmissive units in the second functional device 212 and the change in the physical state of the electromagnetic signal by the transmissive unit may be determined.

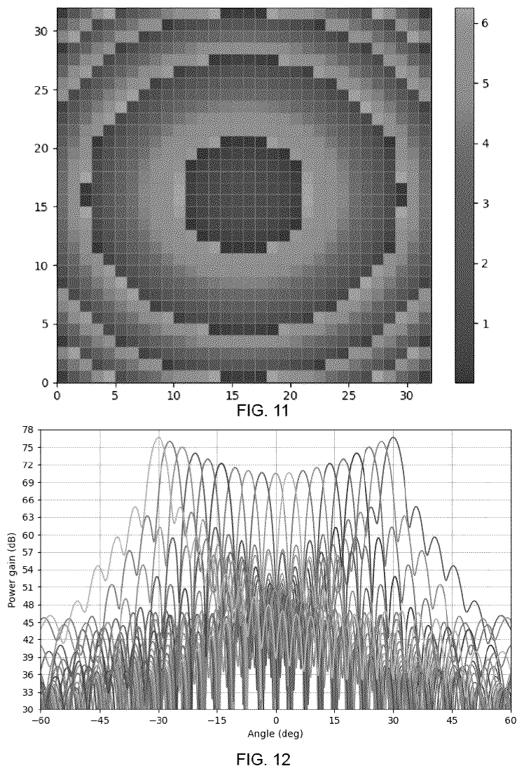

Exemplarily, the structure of the antenna module 210 shown in FIG. 9 is taken as an example, and it is assumed that F=120.0 mm, α=50°, and φ=60°. It is assumed that the surface where the first functional device 211 is located is an ellipsoid surface, the center coordinate of the ellipsoid is (0, 0, −73.49), and the lengths of three axes of the ellipsoid are: a=47.54 mm, b=c=79.24 mm. It is assumed that the first functional device 211 includes 19 feed sources therein (as indicated by triangles in FIG. 9). It is assumed that the center of the second functional device 212 is located at the origin of the coordinate axis, the second functional device 212 includes 32*32 transmissive units therein, the spacing between adjacent transmissive units in the x-axis direction and in the y-axis direction is 5 mm, the center coordinates of each transmissive unit satisfy the above Formula (1), and the amount of change in the phase of the electromagnetic signal by each transmissive unit (the physical state of the transmissive unit includes the phase) satisfies the above Formula (2), the phase response of the transmissive unit in the second functional device 212 (i.e., the amount of change in the phase of the electromagnetic signal by the transmissive unit) may be in the form shown in FIG. 11.

Based on the structure of the antenna module 210 shown in FIG. 9 and FIG. 11, a beam scanning within a range of ±30° may be achieved by switching the feed source in the first functional device 211 by the feed source selecting module 230. Exemplarily, by switching 19 feed sources in the first functional device 211 by the feed source selecting module 230, the direction and the gain of the beam radiated outward, through the transmissive unit in the second functional device 212, of the electromagnetic signal transmitted from each feed source are in the form shown in FIG. 12.

It can be understood that in the antenna module 210 provided in the embodiments of the present disclosure, the surface where the first functional device 211 is located is a curved surface, and the M feed sources in the first functional device 211 are arranged in a curved surface array or a curved line array; and the surface where the second functional device 212 is located is a curved surface, and the N transmissive units in the second functional device 212 are arranged in a curved surface array. In this way, the antenna module 210 follows the principle of equal optical path when both transmitting an electromagnetic signal and receiving an electromagnetic signal, so that the performance of the beam that is radiated out is improved. Also, in the antenna module 210 provided in the embodiments of the present disclosure, the phase shifter may be replaced with a feed source selecting module to achieve beam manipulation, which can reduce design complexity, reduce cost, and reduce power consumption.

Implementation two: the surface where the first functional device 211 is located is a plane, and the surface where the second functional device 212 is located is a plane.

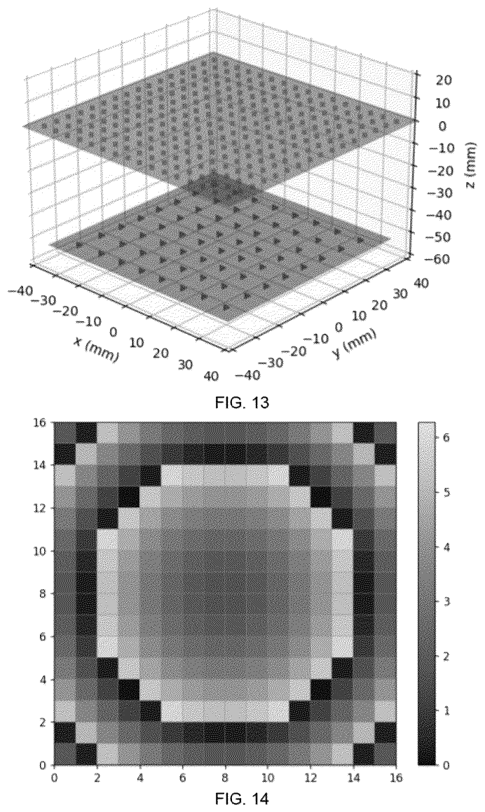

In some embodiments, as shown in FIG. 13, the surface where the first functional device 211 is located is a plane, and the surface where the second functional device 212 is located is a plane. In some embodiments, the first functional device 211 is parallel to the second functional device 212. The M feed sources in the first functional device 211 are arranged in an array, and the N transmissive units in the second functional device 212 are arranged in an array.

In some embodiments, the M feed sources in the first functional device 211 are arranged in an array with equal spacings; or, the M feed sources in the first functional device 211 are arranged in an array with unequal spacings. In addition, the embodiments of the present disclosure do not limit the array arrangement manner of the M feed sources. For example, as shown in FIG. 6A, the M feed sources may have an array arrangement manner of a checkerboard pattern. For another example, as shown in FIG. 6B, the M feed sources may have an array arrangement manner of a radial pattern. For another example, as shown in FIG. 6C, the array arrangement manner may be an array arrangement manner of an annulus.

In some embodiments, the N transmissive units in the second functional device 212 are arranged in an array with equal spacings; or, the N transmissive units in the second functional device 212 are arranged in an array with unequal spacings. In addition, the embodiments of the present disclosure do not limit the array arrangement manner of the N transmissive units. For example, as shown in FIG. 6A, the N transmissive units may have an array arrangement manner of a checkerboard pattern. For another example, as shown in FIG. 6B, the N transmissive units may have an array arrangement manner of a radial pattern. For another example, as shown in FIG. 6C, the array arrangement manner may be an array arrangement manner of an annulus.

In some embodiments, the positions of the M feed sources in the first functional device 211, the positions of the N transmissive units in the second functional device 212, and the change in the physical state of the electromagnetic signal by the N transmissive units are determined according to the principle of equal optical path, so that a first electromagnetic signal transmitted out from a feed source in the first functional device 211 may be radiated outward through the N transmissive units in the second functional device 212 to form a directional beam.

Exemplarily, the structure of the antenna module 210 shown in FIG. 13 is taken as an example. The surface where the second functional device 212 is located is a plane, and the center point of the surface where the second functional device 212 is located is the coordinate origin, and the N transmissive units may be arranged with equal spacings along the x-axis direction and the y-axis direction. It is assumed that the N transmissive units in the second functional device 212 are arranged in a checkerboard array, the center coordinate of the transmissive unit located in an n-th row and an m-th column of the second functional device 212 may satisfy the following Formula (3) according to the principle of equal optical path:

rₙₘ=((n−0.5N−0.5)dₓ,(m−0.5M−0.5)d_{y},0) Formula (3)
where dₓ is a spacing between two adjacent transmissive units in the x-axis direction, d_{y} is a spacing between two adjacent transmissive units in the y-axis direction, N is the number of transmissive units in the x-axis direction, M is the number of transmissive units in the y-axis direction, n={1, 2, . . . , N}, and m={1, 2, . . . , M}.

It is assumed that the center coordinate of an nₜ-th feed source in the first functional device 211 is r_{n,t}=(x_{n,t}, y_{n,t}, z_{n,t}), and a beam direction corresponding to the electromagnetic signal transmitted from the nₜ-th feed source is (θₙ, φₙ), where θₙ and φₙ are an inclination angle and an azimuth angle in a spherical coordinate system with a normal direction of the plane where the second functional device 212 is located as a polar axis. According to the principle of equal optical path, the center coordinate of the nₜ-th feed source is r_{n,t}=(x_{n,t}, y_{n,t}, z_{n,t}) and the beam direction corresponding to the transmitted electromagnetic signal is (θₙ, φₙ), which may satisfy the following Formula (4):

$${max}_{{r}_{t , i}} {\vert {\sum }_{i = 1}^{{N}_{t}} {\sum }_{n = 1}^{N} {\sum }_{m = 1}^{M} \frac{1}{\vert {r}_{t , i} - {r}_{nm} \vert} {e}^{jk ( \vert {r}_{t , i} - {r}_{nm} \vert + {ϕ}_{m} + {nd}_{x} sin {θ}_{i} cos {φ}_{i} + {md}_{y} sin {θ}_{i} sin {φ}_{i} )} \vert}^{2} , \qquad Formula ( 4 )$$

$$subject to \vert {r}_{t , i} \vert \leq R ,$$

where k is a beam corresponding to a center frequency f_{c} of the electromagnetic signal transmitted from the nₜ-th feed source, i.e., k=2πf_{c}/c, and c is a propagation rate of the electromagnetic signal between the first functional device 211 and the second functional device 212.

It can be understood that the above Formula (4) is a constraint-solving method, that is, by solving Formula (4), the position of the nₜ-th feed source that satisfies the constraint condition may be obtained, where the constraint condition may be that: the electromagnetic signal transmitted from the nₜ-th feed source in the first functional device 211 radiates out a maximum power beam outward through the transmissive unit in the second functional device 212. In some other embodiments, artificial intelligence algorithms, such as deep learning, etc., may also be adopted to perform solving.

Exemplarily, in the structure of the antenna module 210 shown in FIG. 13, a carrier center frequency is 30 GHz. The first functional device 211 includes 64 feed sources (e.g., the triangular dot matrix shown in FIG. 13), and each of the feed sources may generate a directional beam (i.e., the electromagnetic signal transmitted from each feed source radiates outward through the transmissive units in the second functional device 212 to form a directional beam). The 64 feed sources in the first functional device 211 are arranged in an array with unequal spacings. For example, the positions of the 64 feed sources in the first functional device 211 may be obtained by solving the above Formula (4). Exemplarily, the coordinates of the positions of the 64 feed sources are shown in the following Table 1, and the z-axis coordinates are omitted in Table 1 because all feed sources are located in the same plane and all the z-axis coordinates have a value of −53.03 mm.

TABLE 1

| serial | | |
|---|---|---|
| number | x(mm) | y(mm) |
| 1 | −4.09 | −4.09 |
| 2 | −12.40 | −4.13 |
| 3 | −21.11 | −4.17 |
| 4 | −30.45 | −4.26 |
| 5 | −4.12 | −12.40 |
| 6 | −12.48 | −12.49 |
| 7 | −21.19 | −12.63 |
| 8 | −30.51 | −12.75 |
| 9 | −4.21 | −21.07 |
| 10 | −12.63 | −21.20 |
| 11 | −21.34 | −21.34 |
| 12 | −30.54 | −21.46 |
| 13 | −4.23 | −30.48 |
| 14 | −12.81 | −30.45 |
| 15 | −21.46 | −30.54 |
| 16 | −30.64 | −30.65 |
| 17 | −4.09 | 4.09 |
| 18 | −12.40 | 4.13 |
| 19 | −21.11 | 4.17 |
| 20 | −30.45 | 4.26 |
| 21 | −4.12 | 12.40 |
| 22 | −12.48 | 12.49 |
| 23 | −21.19 | 12.63 |
| 24 | −30.51 | 12.75 |
| 25 | −4.21 | 21.07 |
| 26 | −12.63 | 21.20 |
| 27 | −21.34 | 21.34 |
| 28 | −30.54 | 21.46 |
| 29 | −4.23 | 30.48 |
| 30 | −12.81 | 30.45 |
| 31 | −21.46 | 30.54 |
| 32 | −30.64 | 30.65 |
| 33 | 4.09 | −4.09 |
| 34 | 12.40 | −4.13 |
| 35 | 21.11 | −4.17 |
| 36 | 30.45 | −4.26 |
| 37 | 4.12 | −12.40 |
| 38 | 12.48 | −12.49 |
| 39 | 21.19 | −12.63 |
| 40 | 30.51 | −12.75 |
| 41 | 4.21 | −21.07 |
| 42 | 12.63 | −21.20 |
| 43 | 21.34 | −21.34 |
| 44 | 30.54 | −21.46 |
| 45 | 4.23 | −30.48 |
| 46 | 12.81 | −30.45 |
| 47 | 21.46 | −30.54 |
| 48 | 30.64 | −30.65 |
| 49 | 4.09 | 4.09 |
| 50 | 12.40 | 4.13 |
| 51 | 21.11 | 4.17 |
| 52 | 30.45 | 4.26 |
| 53 | 4.12 | 12.40 |
| 54 | 12.48 | 12.49 |
| 55 | 21.19 | 12.63 |
| 56 | 30.51 | 12.75 |
| 57 | 4.21 | 21.07 |
| 58 | 12.63 | 21.20 |
| 59 | 21.34 | 21.34 |
| 60 | 30.54 | 21.46 |
| 61 | 4.23 | 30.48 |
| 62 | 12.81 | 30.45 |
| 63 | 21.46 | 30.54 |
| 64 | 30.64 | 30.65 |

It can be understood that, in actual applications, the feed sources in the first functional device 211 may also be arranged in an array with equal spacings, which is not limited in the embodiments of the present disclosure. When the feed sources in the first functional device 211 are arranged in an array with equal spacings, a beam in a specified direction may be generated by an electromagnetic signal transmitted from a part or all of the feed sources in the first functional device 211; and multiple beams in specified directions may be generated by electromagnetic signals transmitted from a part or all of the feed sources in the first functional device that is connected to the multiple radio frequency links simultaneously.

The transmissive units in the second functional device 212 are arranged in a 16*16 array with equal spacings (e.g., a square dot matrix as shown in FIG. 13), and the spacing between adjacent transmissive units in the x-axis direction and in the y-axis direction is 5 mm. The distance between the first functional device 211 and the second functional device 212 is 53.05 mm. Exemplarily, the center coordinates of respective transmissive units in the second functional device 212 satisfy the above Formula (3), and the amount of change in the phase of respective transmissive units may satisfy the above Formula (2), the phase response of the transmissive unit in the second functional device 212 may be in the form shown in FIG. 14.

It can be understood that, in the antenna module 210 provided in the embodiments of the present disclosure, the surface where the first functional device 211 is located is a plane, and the M feed sources in the first functional device 211 are arranged in a planar array; and the surface where the second functional device 212 is located is a curved surface, and the N transmissive units in the second functional device 212 are arranged in a planar array. In this way, the antenna module 210 has a relatively simple structure and is easy to design and manufacture.

Implementation three: the surface where the first functional device 211 is located is a curved surface, and the surface where the second functional device 212 is located is a plane.

In some embodiments, as shown in FIG. 15, the surface where the first functional device 211 is located is a curved surface, and the surface where the second functional device 212 is located is a plane. Projections of the M feed sources in the first functional device 211 on a first plane are arranged in an array, and the N transmissive units in the second functional device 212 are arranged in an array, where the first plane is a plane perpendicular to the first direction.

In some embodiments, the projections of the M feed sources in the first functional device 211 on the first plane are arranged in an array with equal spacings; or, the projections of the M feed sources in the first functional device 211 on the first plane are arranged in an array with unequal spacings. In addition, the embodiments of the present disclosure do not limit the array arrangement manner of the M feed sources. For example, as shown in FIG. 8A, the projections of the M feed sources on the first plane may have an array arrangement manner of a checkerboard pattern. For another example, as shown in FIG. 8B, the projections of the M feed sources on the first plane may have an array arrangement manner of a radial pattern.

In some embodiments, the N transmissive units in the second functional device 212 are arranged in an array with equal spacings; or, the N transmissive units in the first functional device 211 are arranged in an array with unequal spacings. In addition, the embodiments of the present disclosure do not limit the array arrangement manner of the N transmissive units. For example, as shown in FIG. 6A, the N transmissive units may have an array arrangement manner of a checkerboard pattern. For another example, as shown in FIG. 6B, the N transmissive units may have an array arrangement manner of a radial pattern. For another example, as shown in FIG. 6C, the array arrangement manner may be an array arrangement manner of an annulus.

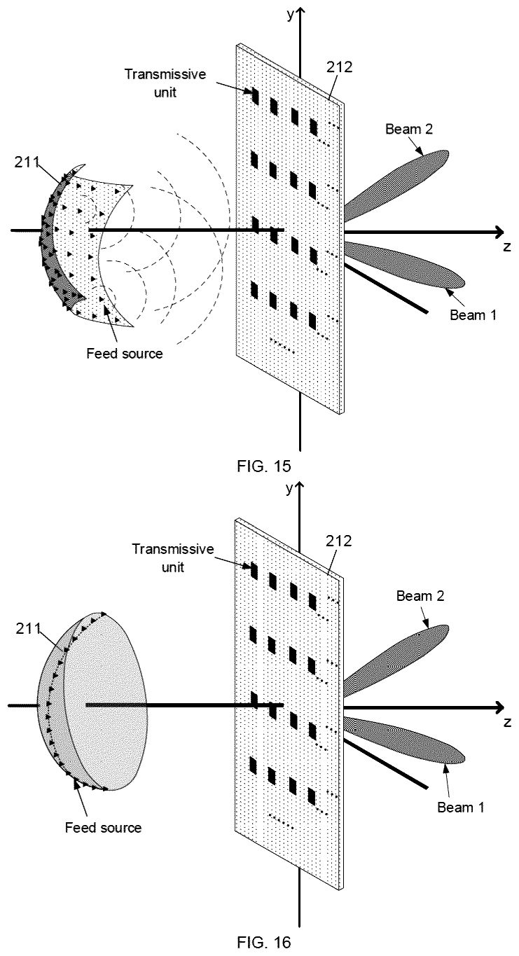

In some embodiments, as shown in FIG. 16, at least one feed source of the M feed sources in the first functional device 211 is arranged on an intersection line of the first functional device 211 with a second plane (not shown in FIG. 16) (in FIG. 16, that all the M feed sources are arranged on the intersection line of the first functional device 211 with the second plane is taken as an example). The second plane is a plane intersecting with the first functional device 211 and parallel to the first direction. The projections of the N transmissive units in the second functional device 212 on the first plane are arranged in an array.

It can be understood that the embodiments of the present disclosure do not limit the array arrangement manner of the M feed sources in the first functional device 211. Exemplarily, when the array arrangement manner of the M feed sources in the first functional device 211 is a one-dimensional arrangement manner (e.g., a linear array or a curved line array), a one-dimensional beam scanning may be achieved; and when the array arrangement manner of the M feed sources in the first functional device 211 is a two-dimensional arrangement manner (e.g., a planar array or a curved surface array), a two-dimensional beam scanning may be achieved. It can be seen that the antenna module 210 provided in the embodiments of the present disclosure may achieve beam manipulation by changing the array arrangement manner.

In some embodiments, according to the principle of equal optical path, the positions of the M feed sources in the first functional device 211, the positions of the N transmissive units in the second functional device 212, and the change in the physical state of the electromagnetic signal by the N transmissive units are determined, so that a first electromagnetic signal transmitted out from a feed source in the first functional device 211 may be radiated outward through the N transmissive units in the second functional device 212 to form a directional beam.

Exemplarily, the manner for determining the positions of the M feed sources in the first functional device 211 may refer to the above implementation one; the positions of the N transmissive units in the second functional device 212 may refer to the Formula (1) in the above implementation one; and the amount of change in the phase of the electromagnetic signal by the N transmissive units in the second functional device 212 may refer to the above Formula (2), which will not be repeated here.

It can be understood that in addition to the forms of the antenna module 210 shown in the implementation one and in the implementation two, the antenna module 210 provided in the embodiments of the present disclosure may also be in other forms. For example, the surface where the first functional device 211 is located is a curved surface, and the M feed sources in the first functional device 211 are arranged in a curved surface array or a curved line array; and the surface where the second functional device 212 is located is a plane, and the N transmissive units in the second functional device 212 are arranged in a planar array. In this way, compared with the structure of the antenna module 210 provided in the implementation one, the structure is relatively simple and easy to design and manufacture. Compared with the structure of the antenna module 210 provided in the implementation two, the M feed sources in the first functional device 211 are arranged in a curved surface array or a curve line array, and can follow the principle of equal optical path when transmitting an electromagnetic signal and receiving an electromagnetic signal, thereby improving the performance of the beam that is radiated out.

Implementation four: the surface where the first functional device 211 is located is a plane, and the surface where the second functional device 212 is located is a curved surface.

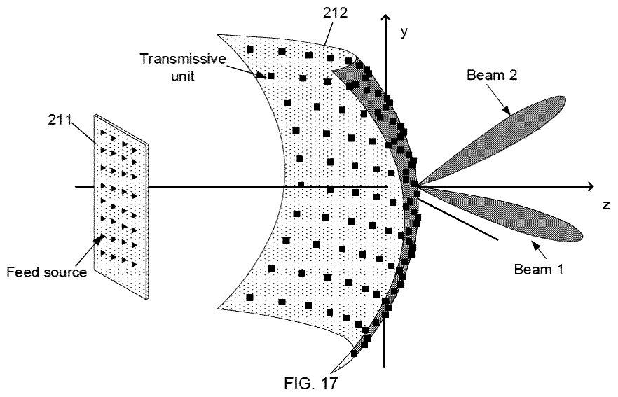

In some embodiments, as shown in FIG. 17, the surface where the first functional device 211 is located is a plane, and the surface where the second functional device 212 is located is a curved surface. The M feed sources in the first functional device 211 are arranged in an array, and the projections of the N transmissive units in the second functional device 212 on a first plane are arranged in an array, where the first plane is a plane perpendicular to the first direction.

In some embodiments, the M feed sources in the first functional device 211 are arranged in an array with equal spacings; or, the M feed sources in the first functional device 211 are arranged in an array with unequal spacings. In addition, the embodiments of the present disclosure do not limit the array arrangement manner of the M feed sources. For example, as shown in FIG. 6A, the M feed sources may have an array arrangement manner of a checkerboard pattern. For another example, as shown in FIG. 6B, the M feed sources may have an array arrangement manner of a radial pattern. For another example, as shown in FIG. 6C, the array arrangement manner may be an array arrangement manner of an annulus.

In some embodiments, the projections of the N transmissive units in the second functional device 212 on the first plane are arranged in an array with equal spacings; or, the projections of the N transmissive units in the first functional device 211 on the first plane are arranged in an array with unequal spacings. In addition, the embodiments of the present disclosure do not limit the array arrangement manner of the N transmissive units. For example, the projections of the N transmissive units on the first plane may have an array arrangement manner of a checkerboard pattern. For another example, the projections of the N transmissive units on the first plane may have an array arrangement manner of a radial pattern.

In some embodiments, according to the principle of equal optical path, the positions of the M feed sources in the first functional device 211, the positions of the N transmissive units in the second functional device 212, and the change in the physical state of the electromagnetic signal by the N transmissive units are determined, so that a first electromagnetic signal transmitted out from a feed source in the first functional device 211 may be radiated outward through the N transmissive units in the second functional device 212 to form a directional beam.

Exemplarily, the manner for determining the positions of the M feed sources in the first functional device 211 may refer to the above implementation two; the positions of the N transmissive units in the second functional device 212 may refer to the Formula (3) in the above implementation one; the amount of change in the phase of the electromagnetic signal by the N transmissive units in the second functional device 212 may refer to the Formula (2) in the above implementation one, which will not be repeated here.

It can be understood that, in the antenna module 210 provided in the embodiments of the present disclosure, the surface where the first functional device 211 is located is a plane, and the M feed sources in the first functional device 211 are arranged in a planar array; and the surface where the second functional device 212 is located is a curved surface, and the N transmissive units in the second functional device 212 are arranged in a curved surface array. In this way, compared with the structures of the antenna module 210 provided in the implementation one and the implementation two, the structure is relatively simple and easy to design and manufacture. Compared with the structure of the antenna module 210 provided in the implementation two, the N transmissive units in the second functional device 212 are arranged in a curved surface array, and can follow the principle of equal optical path when transmitting an electromagnetic signal and receiving an electromagnetic signal, thereby improving the performance of the beam that is radiated out.

In some embodiments, the embodiments of the present disclosure further provide an electronic device, where the electronic device includes the antenna 200 provided in the embodiments of the present disclosure. In some embodiments, the electronic device may be used for wireless communication, or the electronic device may be used for wireless positioning.

Exemplarily, the electronic device may be used for wireless communication. For example, the electronic device may transmit outward a first electromagnetic signal by the antenna 200, and receive a second electromagnetic signal radiated from an external space. The electromagnetic signal may carry communication data therein, e.g., a call request, etc.

Exemplarily otherwise, the electronic device may be used for wireless positioning. For example, the electronic device may transmit by the antenna 200 a first electromagnetic signal for positioning, and receive a second electromagnetic signal that is transmitted back, and then determine information of objects in the environment, e.g., location information of an object, a moving speed of an object, etc., according to the second electromagnetic signal that is transmitted back.

Although the present disclosure is described herein in conjunction with respective embodiments, other variations of the embodiments of the present disclosure may be understood and implemented by those skilled in the art by viewing the drawings, the disclosed content, and the claims as attached, during the implementation of the present disclosure for which the protection is claimed. In the claims, the word “comprise/comprises/comprising” does not exclude other components or steps, and “a/an” or “one” does not exclude a plurality. A single processor or other unit may fulfill functions of several items recited in the claims. A fact that certain measures are documented in different dependent claims from each other does not mean that these measures cannot be combined to exert a good effect.

Although the present disclosure is described in conjunction with specific features and embodiments thereof, it will be apparent that various modifications and combinations can be made thereto without departing from the scope of the present disclosure. Accordingly, the specification and drawings herein are merely illustrative of the present disclosure as defined by the claims as attached and are deemed to cover any and all modifications, variations, combinations or equivalents within the scope of the present disclosure. Obviously, those skilled in the art can make various changes and modifications to the present disclosure without departing from the scope of the present disclosure. In this way, if these modifications and variations of the present disclosure fall within the scope of the claims of the present disclosure and their equivalent technologies, the present disclosure is also intended to include these modifications and variations.

The above are only specific implementation of the present disclosure, but the protection scope of the present disclosure is not limited thereto, and any variations or replacements within the technical scope disclosed in the present disclosure shall fall within the protection scope of the present disclosure. Therefore, the protection scope of the present disclosure shall be subject to the protection scope of the claims.

What is claimed is:

1. An antenna, comprising a first functional device and a second functional device sequentially spaced apart in a first direction; wherein
the first functional device comprises M feed sources; each feed source of the M feed sources is used to transmit a first electromagnetic signal, wherein the M is an integer greater than or equal to 2;
the second functional device comprises N transmissive units, each transmissive unit of the N transmissive units is configured to change a physical state of an electromagnetic signal passing through the transmissive unit; and the physical state of the electromagnetic signal comprises one or more of: an amplitude, a phase, a frequency and a polarization direction; wherein the N is an integer greater than or equal to 2; and
a distance between the first functional device and the second functional device is less than or equal to a preset multiple of a distance between two farthest-spaced transmissive units in the second functional device.

2. The antenna according to claim 1, wherein m feed sources among the M feed sources are used to transmit the first electromagnetic signal, respectively; the N transmissive units are configured to receive the first electromagnetic signal and radiate outward the first electromagnetic signal, to form directional beams in k specified directions; wherein the m is an integer greater than or equal to 1 and less than or equal to the M, and the k is an integer greater than or equal to 1 and less than or equal to the m.

3. The antenna according to claim 1, wherein in the first direction, a projection of the first functional device is at least partially projected onto the second functional device.

4. The antenna according to claim 1, wherein each transmissive unit of the N transmissive units comprises: a first patch, a second patch and a dielectric substrate; the dielectric substrate is sandwiched between the first patch and the second patch; wherein the first patch and the second patch are used to adjust the physical state of the electromagnetic signal passing through the transmissive unit.

5. The antenna according to claim 1, wherein a distance between two farthest-spaced feed sources in the first functional device is smaller than the distance between the two farthest-spaced transmissive units in the second functional device.

6. The antenna according to claim 1, wherein a surface where the first functional device is located is a curved surface, and a surface where the second functional device is located is a curved surface; projections of the M feed sources in the first functional device on a first plane are arranged in an array, and projections of the N transmissive units in the second functional device on the first plane are arranged in an array; wherein the first plane is perpendicular to the first direction.

7. The antenna according to claim 1, wherein a surface where the first functional device is located is a curved surface, and a surface where the second functional device is located is a plane; projections of the M feed sources in the first functional device on a first plane are arranged in an array, and the N transmissive units in the second functional device are arranged in an array; wherein the first plane is perpendicular to the first direction.

8. The antenna according to claim 1, wherein a surface where the first functional device is located is a plane, and a surface where the second functional device is located is a curved surface; the M feed sources in the first functional device are arranged in an array, and projections of the N transmissive units in the second functional device on a first plane are arranged in an array; wherein the first plane is perpendicular to the first direction.

9. The antenna according to claim 1, wherein a surface where the first functional device is located is a plane, and a surface where the second functional device is located is a plane; the M feed sources in the first functional device are arranged in an array, and the N transmissive units in the second functional device are arranged in an array.

10. The antenna according to claim 6, wherein at least one feed source of the M feed sources in the first functional device is arranged on an intersecting line of the first functional device with a second plane; wherein the second plane is a plane intersecting with the first functional device and parallel to the first direction.

11. The antenna according to claim 1, wherein the first functional device intersects with the second functional device, and a cavity is formed between the first functional device and the second functional device; the first electromagnetic signal transmitted from each feed source of the M feed sources is transmitted from an inside of the cavity to an outside of the cavity by the transmissive unit.

12. The antenna according to claim 1, further comprising a filling material, wherein the filling material is located between the first functional device and the second functional device; the filling material comprises air or a dielectric material; wherein a dielectric constant of the dielectric material is greater than a preset threshold.

13. The antenna according to claim 1, wherein the antenna further comprises a signal processing module and a feed source selecting module; the signal processing module is coupled to the feed source selecting module; and the feed source selecting module is coupled to the M feed sources in the first functional device;
the signal processing module is configured to generate the first electromagnetic signal; and
the feed source selecting module is configured to select a target feed source from the M feed sources, so that the target feed source transmits the first electromagnetic signal.

14. The antenna according to claim 13, wherein the N transmissive units are further configured to receive a second electromagnetic signal radiated from an external space and sends the second electromagnetic signal to m feed sources among the M feed sources; the m feed sources are used to transmit the second electromagnetic signal to the signal processing module; and the signal processing module is further configured to process the second electromagnetic signal; wherein the m is an integer greater than or equal to 1 and less than the M.

15. An electronic device, comprising an antenna, wherein the antenna comprises a first functional device and a second functional device sequentially spaced apart in a first direction;
the first functional device comprises M feed sources; each feed source of the M feed sources is used to transmit a first electromagnetic signal, wherein the M is an integer greater than or equal to 2;
the second functional device comprises N transmissive units, each transmissive unit of the N transmissive units is configured to change a physical state of an electromagnetic signal passing through the transmissive unit; and the physical state of the electromagnetic signal comprises one or more of: an amplitude, a phase, a frequency and a polarization direction; wherein the N is an integer greater than or equal to 2; and
a distance between the first functional device and the second functional device is less than or equal to a preset multiple of a distance between two farthest-spaced transmissive units in the second functional device.

16. A communication base station, comprising an electronic device, wherein the electronic device comprises an antenna, and the antenna comprises a first functional device and a second functional device sequentially spaced apart in a first direction;
the first functional device comprises M feed sources; each feed source of the M feed sources is used to transmit a first electromagnetic signal, wherein the M is an integer greater than or equal to 2;
the second functional device comprises N transmissive units, each transmissive unit of the N transmissive units is configured to change a physical state of an electromagnetic signal passing through the transmissive unit; and the physical state of the electromagnetic signal comprises one or more of: an amplitude, a phase, a frequency and a polarization direction; wherein the N is an integer greater than or equal to 2; and
a distance between the first functional device and the second functional device is less than or equal to a preset multiple of a distance between two farthest-spaced transmissive units in the second functional device.

17. The antenna according to claim 7, wherein at least one feed source of the M feed sources in the first functional device is arranged on an intersecting line of the first functional device with a second plane; wherein the second plane is a plane intersecting with the first functional device and parallel to the first direction.

18. The antenna according to claim 8, wherein at least one feed source of the M feed sources in the first functional device is arranged on an intersecting line of the first functional device with a second plane; wherein the second plane is a plane intersecting with the first functional device and parallel to the first direction.

19. The antenna according to claim 9, wherein at least one feed source of the M feed sources in the first functional device is arranged on an intersecting line of the first functional device with a second plane; wherein the second plane is a plane intersecting with the first functional device and parallel to the first direction.

20. The antenna according to claim 1, wherein the N transmissive units are further configured to receive a second electromagnetic signal radiated from an external space and sends the second electromagnetic signal to m feed sources among the M feed sources; the m feed sources are used to transmit the second electromagnetic signal to a signal processing module; and the signal processing module is configured to process the second electromagnetic signal; wherein the m is an integer greater than or equal to 1 and less than the M.
